(19) United States
(12) Patent Application Publication
(10) Pub. No.: US 2026/0146204 A1
(43) Pub. Date: May 28, 2026

(54) NEAR-CRITICAL FLUID-ASSISTED INTEGRATED LIQUEFACTION-EXTRACTION (NILE) SYSTEMS AND METHODS FOR PROCESSING ORGANIC MATERIALS

(71) Applicant: UNIVERSITY OF MARYLAND, COLLEGE PARK, College Park, MD (US)

(72) Inventors: Ashwani K. GUPTA, College Park, MD (US); Kiran Raj Goud BURRA, College Park, MD (US)

(21) Appl. No.: 19/399,102

(22) Filed: Nov. 24, 2025

Related U.S. Application Data
(60) Provisional application No. 63/725,492, filed on Nov. 26, 2024.

(51) Int. Cl. C10G 1/04; B01J 19/00; C10G 1/00

(52) U.S. Cl. CPC C10G 1/045; B01J 19/0013; C10G 1/008; B01J 2219/0871; C10G 2300/1003; C10G 2300/1011

(57) ABSTRACT

Organic feedstock, such as a biomass or waste stream, can be provided to a reactor with one or more solvents, at least one of which can be a supercritical fluid. The feedstock and the solvent(s) in the reactor can be subject to one or more conditions that cause liquefaction of the feedstock, so as to convert the feedstock into biocrude and one or more by-products. The one or more solvents with the biocrude dissolved therein can then be flowed from the reactor, such that the biocrude is separated from the one or more by-products. The supercritical fluid can thus be part of the liquefaction and extraction processes. In some examples, the supercritical fluid can also be used to remove at least some water from the organic feedstock prior to the liquefaction.

### CROSS-REFERENCE TO RELATED APPLICATIONS

The present application claims the benefit of and priority under 35 U.S.C. § 119(e) to and is a non-provisional of U.S. Provisional Application No. 63/725,492, filed Nov. 26, 2024, entitled “Near-Critical Liquefaction-Extraction For Biofuels,” which is hereby incorporated by reference herein in its entirety.

### STATEMENT REGARDING FEDERALLY SPONSORED RESEARCH

This invention was made with government support under DE-EE0009757 awarded by the U.S. Department of Energy. The government has certain rights in the invention.

### STATEMENT REGARDING PRIOR DISCLOSURES

Pursuant to 35 U.S.C. § 102(b)(1)(A), the following was published by the instant inventors, which is incorporated by reference herein in its entirety:

BURRA et al., “Near-Critical CO₂-Assisted Liquefaction-Extraction of Biomass and Wastes to Fuels and Value-Added Products,” ASME Journal of Energy Resources Technology, January 2024, 146:011801.

### FIELD

The present disclosure relates generally to processing organic materials, for example, to generate liquid fuel or precursors thereof, and more particularly, to conversion of organic materials by integrated liquefaction-extraction using a supercritical fluid.

### BACKGROUND

Conventional thermochemical conversion pathways, such as fast pyrolysis and hydrothermal liquefaction (HTL), have been used to produce an intermediate liquid known as biocrude or bio-oil. However, this raw liquid is generally not suitable for direct use as a fuel, because it is an unstable, corrosive, and complex mixture characterized by high average molecular weights, high acidity, high viscosity, and a high content of both water and oxygen. Moreover, such properties can make the biocrude or bio-oil incompatible with existing petroleum refinery infrastructure. For example, attempts to upgrade the biocrude or bio-oil via hydrotreating can be impeded by coking, plugging issues, and rapid catalyst deactivation.

To address these challenges, downstream separation and upgrading processes have been developed to “clean” low-quality bio-oil after it has already been produced, for example, by using supercritical carbon dioxide as a solvent for downstream extraction to reduce metal content, viscosity, and acidity of the bio-oil. However, this approach is fundamentally limited as it only functions as an additional, energy-intensive post-processing step. Moreover, the supercritical carbon dioxide extraction is unable to resolve the high oxygen content in the bio-oil, which may otherwise remain largely comparable to that of the initial feed.

Embodiments of the disclosed subject matter may address one or more of the above-noted problems and disadvantages, among other things.

### SUMMARY

Embodiments of the disclosed subject matter provide systems and methods for processing of organic material, such as biomass and/or waste streams, via near-critical fluid-assisted integrated liquefaction-extraction. In some embodiments, the processing can convert the organic material to biocrude, which can then be further processed (e.g., via hydro-treating and/or distillation) to form value-added products, such as liquid fuel (e.g., jet fuel, gasoline, diesel fuel, etc.). The liquefaction-extraction process can employ one or more solvents, at least one of which is a supercritical fluid (e.g., CO₂). In some embodiments, liquefaction of the feedstock can be performed in the reactor by subjecting the feedstock and solvent(s) to an elevated temperature (e.g., ≥150° C.) and/or pressure (e.g., ≥100 bar), and extraction can be performed by removing from the reactor the solvent(s) with biocrude dissolved therein, leaving behind the one or more by-products (e.g., within, or separately removed from, the reactor). In some embodiments, the supercritical fluid can also be used to remove at least some water from the feedstock, for example, prior to liquefaction and extraction. In some embodiments, the one or more solvents can include one or more co-solvents, such as a polar solvent, organic solvent, or gas-phase solvent. For example, the co-solvent(s) can include residual water retained within the feedstock.

In one or more embodiments, a method can comprise providing organic feedstock in a reactor with one or more solvents. The one or more solvents can comprise a supercritical fluid. The method can further comprise subjecting the organic feedstock and the one or more solvents in the reactor to one or more conditions (e.g., temperature, pressure) that cause liquefaction (e.g., pyrolytic liquefaction) of the organic feedstock, so as to convert the organic feedstock into biocrude and one or more by-products. The method can also comprise, after the subjecting, flowing the one or more solvents with the biocrude dissolved therein from the reactor, such that the biocrude is separated from the one or more by-products.

In one or more embodiments, a system can comprise one or more supplies of one or more solvents, a reactor, a fluidic network, and a controller. The fluidic network can interconnect the one or more supplies and the reactor. The controller can comprise one or more processors and one or more non-transitory computer-readable storage media. The computer-readable storage media can store computer-readable instructions that, when executed by the one or more processors, cause the system to provide organic feedstock in the reactor with the one or more solvents via the fluidic network; subject the organic feedstock and the one or more solvents in the reactor to one or more conditions that cause liquefaction of the organic feedstock, so as to convert the organic feedstock into biocrude and one or more by-products; and flow the one or more solvents with the biocrude dissolved therein from the reactor via the fluidic network, such that the biocrude is separated from the one or more by-products. The one or more solvents in the reactor can comprise a supercritical fluid.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram illustrating aspects of a near-critical fluid-assisted integrated liquefaction-extraction (NILE) system, according to one or more embodiments of the disclosed subject matter.

FIG. 2 is a simplified schematic diagram illustrating additional details of an exemplary NILE system, according to one or more embodiments of the disclosed subject matter.

FIGS. 3A-3D illustrate different configurations for a reactor of the NILE system of FIG. 2, according to one or more embodiments of the disclosed subject matter.

FIG. 4 is a process flow diagram illustrating aspects of a NILE method, according to one or more embodiments of the disclosed subject matter.

FIG. 5 depicts a generalized example of a computing environment in which the disclosed technologies may be implemented.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.
Near-critical: Processing where at least one (but not all) of the substances is at a temperature and pressure above its critical point. In some embodiments, a first solvent is in a supercritical phase (i.e., at a temperature and pressure above its critical point) while a feedstock and/or other solvents (e.g., co-solvent) are in a liquid or gas phase (i.e., at a temperature or pressure below their critical points, e.g., sub-critical).
Biomass: Plant (e.g., wood, grass, reed, etc.), algae (including both micro-algae and macro-algae), seaweed, or processed or waste versions (e.g., paper processing residue, such as paper mill sludge, pulp, etc. ; yard waste, such as grass clippings, leaves, branches; forestry residues, such as sawdust, wood chips, bark, etc.; agricultural residues, such as bagasse, straw, rice husks, nut shells, corn stover, etc.) or components thereof (e.g., cellulose, hemicellulose, lignin carbohydrates, and/or proteins).
Waste stream: Municipal solid waste (e.g., non-hazardous solid waste generated from residential, commercial, institutional, and limited industrial sources within a municipality, including, for example, plastic waste/recycling materials), wastewater sludge (e.g., the semi-solid or solid residue removed from municipal or industrial wastewater, and including, among other things, food waste and human waste), manure (e.g., excreta collected from animals), and/or industrial waste (e.g., pieces of textiles, food processing waste, etc.).
Biocrude: Hydrocarbon oil produced via liquefaction (e.g., in an atmosphere substantially free of oxygen and/or using a supercritical fluid as solvent). In some embodiments, the biocrude may be non-polar (e.g., hydrophobic) and/or be substantially immiscible in water. Alternatively or additionally, the biocrude can have a relatively low oxygen content (e.g., <20 wt %, such as in a range of 5 -15 wt %, inclusive) and/or a relatively high nitrogen content (e.g., up to 10 wt %). In some embodiments, the biocrude can have a relatively high heating value (e.g., >20 MJ/kg, such as in a range of 30-38 MJ/kg).

### Introduction

Disclosed herein are systems and methods for processing organic materials, in particular, by liquefying an organic feedstock (e.g., biomass, waste streams, and/or other carbonaceous materials) and fractionation of the resulting products via simultaneous extraction using a supercritical fluid solvent. The disclosed integrated processing can yield a superior-quality hydrocarbon oil (e.g., biocrude), which, in some embodiments, can be further processed (e.g., via hydrothermal treatment), for example, to form a biofuel (e.g., gasoline, diesel, jet fuel, etc.). Aspects of the disclosed subject matter are also directed to fast heating (e.g., at a rate of 5-1000° C./minute, inclusive) of feedstock and solvent within a high-pressure chamber (referred to herein as reactor) to form liquefied biocrude dissolved in a supercritical fluid.

In some embodiments, one or more solvents, for example, a supercritical fluid and optionally one or more co-solvents, can be used to convert solid feedstock into biocrude readily separated from undesirable by-products of the conversion, a process referred to herein as near-critical-fluid-assisted integrated liquefaction-extraction (NILE). In some embodiments, the feedstock with one or more solvents can be subjected to moderate temperatures (e.g., in a range of about 150-500° C., inclusive) and/or moderate pressures (e.g., in a range of about 100-500 bar, inclusive) in the reactor for liquefaction (e.g., pyrolytic liquefaction). Such moderate conditions may allow for better scalability and/or reduced capital costs as compared to conventional conversion processes. In some embodiments, the resulting fluid in the reactor, comprised of the liquid products dissolved in the one or more solvents, can be removed for integrated fractionation.

In some embodiments, the supercritical fluid can be supercritical carbon dioxide (CO₂), which has a critical point of 31° C. and 73.8 bar. For example, when using carbon dioxide as the supercritical fluid and low-value solid wastes as the feedstock, embodiments of the disclosed subject matter can offer improved access to renewable liquid fuels. Moreover, the efficient fractionation of oil compounds offered by embodiments of the disclosed subject matter can improve the quality of the biocrude (e.g., heating value, viscosity, stability, lowered metal and heteroatom (O, S) content, etc.), for example, to allow for easier, coke-free, catalyst-poison-free processing into biofuels. This, in turn, can allow for incorporation into existing hydrotreating processes to produce deployable fuel and heavy-oil supplies, as well as provide efficient solid waste and CO₂ utilization that can lower greenhouse gas emissions and/or reduce disposal needs.

In some embodiments, the optional one or more co-solvents can include a polar solvent, an organic solvent, and/or a gas phase solvent. For example, when the co-solvent is a polar solvent, the combination of polar solvent with the non-polar solvent nature of the supercritical fluid can offer tunability with respect to temperature and/or pressure, for example, to allow for in-situ separation of the hydrocarbon-rich liquid products from the solid by-products or aqueous by-products. In some embodiments, the one or more co-solvents can be added to the reactor, for example, mixed with the supercritical fluid introduced to the reactor or separately introduced to the reactor. Alternatively or additionally, in some embodiments, the one or more co-solvents can be included in and/or provided by the organic feedstock, for example, via residual moisture in the feedstock.

Alternatively or additionally, in some embodiments, a portion of the biocrude and/or by-product streams from the process can be recycled and/or re-used, for example, added as one or more co-solvent(s) for the processing. For example, recycling a portion of biocrude and aqueous products from liquefaction can improve biomass conversion and/or increase the quality and/or yield of biocrude while limiting by-products. In some embodiments, the one or more co-solvents, which may include the portion of the biocrude and/or by-product streams, can be incorporated into the biocrude product stream, for example, to act as an additive for improving the quality of the final product.

Compared to conventional technologies for conversion of biomass into biofuels (e.g., low-pressure catalytic pyrolysis and high-pressure liquefaction), embodiments of the disclosed subject matter can offer one or more of the following advantages:
In some embodiments, supercritical-fluid-based de-watering of wet feedstocks can be performed as a feedstock preprocessing step, for example, to remove water and/or adjust residual moisture content to a desirable or predetermined level. Such preprocessing may be performed at relatively low temperatures (e.g., 20-60° C., inclusive) and/or relatively fast durations (e.g., 30-200 minutes, inclusive). Such preprocessing can provide energy efficient adjustment/removal of water from the feedstock in order to improve overall process energy utilization.
In some embodiments, one, some, or all of the solvents (e.g., supercritical fluid (e.g., CO₂) and optional co-solvents(s)) can be recovered and recycled after use in the NILE process. Such recycling can allow for a lower cost, as well as improved oil extraction efficiency.
Embodiments of the disclosed subject matter can operate at low moisture contents (e.g., ≤10 wt %), which can result in lowered energy needs (e.g., to heat the residual moisture) and/or can avoid (or at least reduce) treatment of processed water by-products that would otherwise result from conventional liquefaction technologies. In some embodiments, the solubilities in the reactor can be further tuned by using density variation of the supercritical fluid and/or adding co-solvent, for example, to allow for the water by-products to be collected separately from the valuable oil products, which can result in improved quality of the biocrude.
Embodiments of the disclosed subject matter can allow for lowered or mitigated transfer of metallic content from the initial feedstock to the resulting biocrude, for example, due to the extraction/fractionation capabilities offered by the use of a supercritical fluid as solvent. Such reduced metal content in the obtained high-quality oil can allow for the biocrude to be processed into fuels without concern (or at least reduced concern) for metal emissions, corrosion, and/or catalyst poisoning of downstream processes and applications.
In some embodiments, fractionated recovery of biocrude can allow for purified oil extraction while avoiding unstable oxygenated compounds from the process, for example, heavily oxygenated oligomers from lignin-type compounds in lignocellulosic biomass. This can allow quality control in the produced oil for efficient downstream processing and improved stability against aging. For example, the oil products extracted via the disclosed NILE technology can allow for mitigation of aging by separating out problematic fractions of the oil, thereby producing high-quality biocrude that is resistant to repolymerization as well as resistant to viscosity and carbonyls changing during storage. This allows for significantly improved storage and transportation of the oil produced unlike conventional technologies.
In some embodiments, fractionated recovery of high-quality biocrude can allow for fine tuning of catalytic hydrotreatment or co-hydrotreatment of the oil downstream, and/or mitigation of catalyst poisoning and coking behavior, which can allow for improved biocarbon conversion into biofuels and/or can provide scalability and versatility to refineries.
In some embodiments, gaseous by-products produced during liquefaction can be reprocessed in the NILE technology, for example, to provide additional CO₂ supply (if needed) for supercritical CO₂, while providing a separate stream of cleaner water from the process.
In some embodiments, fast and localized heating rates can be achieved in the disclosed reactor configurations, so as to provide fast and uniform heating of the feedstock, which can minimize (or at least reduce) energy losses, improve oil yields, and enhance liquefaction throughput. In some embodiments, localized heating can also allow for lowered operational pressure (e.g., by faster operation) and/or for reducing any need to heat all supercritical fluid in the reactor to the feedstock temperature.

### Exemplary Systems for Processing Organic Materials

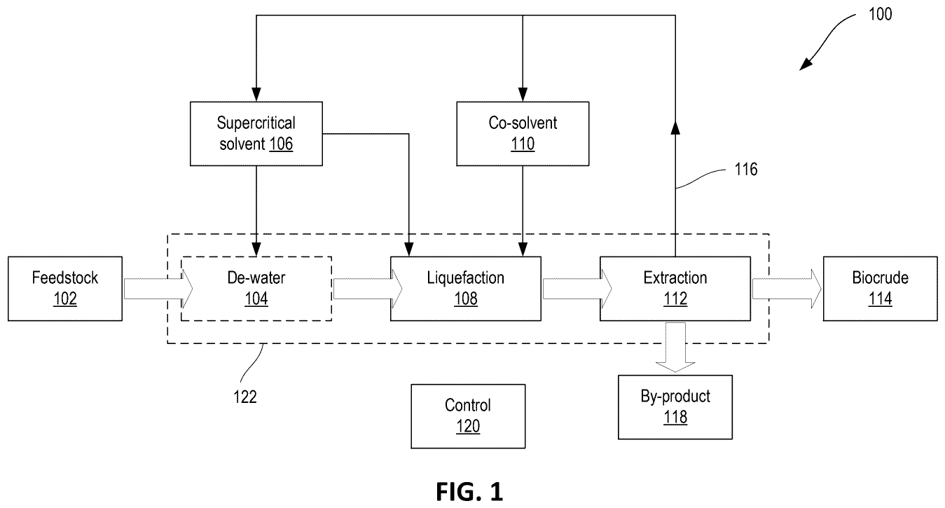

In some embodiments, a NILE system can include a de-watering module, a liquefaction module, and an extraction module for the processing of organic feedstock into biocrude, for example, as illustrated by system 100 in FIG. 1. In the illustrated example, a controller 120 can be operatively connected to and control operation of the various components of the system 100. Organic feedstock 102 can be provided to de-watering module 104, where a supercritical fluid 106 is used to remove at least some water from the feedstock 102, for example, by subjecting to a temperature and pressure above the critical point of the supercritical fluid. For example, the de-watering can be at a temperature in a range of 20-60° C., inclusive, for a time of 30-200 minutes. In some embodiments, the de-watering can be such that the moisture content of the feedstock is less than or equal to 10 wt %, for example, as determined in in accordance with the American Society for Testing and Materials (ASTM) Standard D 4442-20, published Apr. 30, 2020, and entitled “Standard Test Methods for Direct Moisture Content Measurement of Wood and Wood-Based Materials,” which is incorporated by reference herein. In some embodiments, the de-watering module 104 can be omitted, for example, when the moisture content of the organic feedstock is already sufficiently low and/or when the organic feedstock has been previously processed to remove water therefrom.

The feedstock can then be provided to a liquefaction module 108 together with one or more solvents. In some embodiments, the one or more solvents includes the supercritical fluid (e.g., supplied together with the feedstock from the de-watering module 104 and/or input to the liquefaction module 108) and optionally one or more co-solvents 110. In some embodiments, the one or more co-solvents may have one or more properties different from (e.g., complementary to) those of the supercritical fluid. For example, the supercritical fluid may be considered a non-polar solvent, and the one or more co-solvents can include a polar solvent (e.g., water, ethanol, acetone, etc.). Alternatively or additionally, the co-solvent(s) can include an organic solvent, such as but not limited to alcohol (e.g., ethanol), carboxylic acid (e.g., acetic acid), aromatic (e.g., toluene), hydrocarbon (e.g., hexane), halocarbon (e.g., dichloromethane), phenolic (e.g., guaiacol, phenol), aldehyde (e.g., furfural (C₅H₄O₂)), and ketone (e.g., acetone), or a gaseous solvent, such as but not limited to ammonia (NH₃), propane (C₃H₈), and acetylene (C₂H₂). In some embodiments, the co-solvent is provided within or results from the feedstock itself, for example, residual moisture in the feedstock. Alternatively or additionally, in some embodiments, co-solvent(s) can include a portion of biocrude and/or by-product from liquefaction (e.g., water). In some embodiments, one or more catalysts may also be provided to the liquefaction module 108, such as but not limited to alkali or alkaline earth metal carbonates, bicarbonates, aluminates and alumina silicates, and transition metal impregnated catalysts.

In some embodiments, liquefaction (e.g., pyrolytic liquefaction) of the feedstock can be performed by liquefaction module, for example, by subjecting the feedstock and/one or more solvents to one or more conditions (e.g., an elevated temperature and/or pressure) that cause conversion of the feedstock to biocrude and one or more by-products. The biocrude can be dissolved in the one or more solvents (e.g., at least the supercritical fluid), while the by-product(s) can be solids and/or insoluble in the one or more solvents. In some embodiments, the condition(s) for the liquefaction include temperatures and pressures greater than the critical point for the supercritical fluid (e.g., and one or more co-solvents) but less than the critical point for the other co-solvents, such that the liquefaction process is considered near-critical. For example, the liquefaction can be performed at temperatures in a range of 150-500° C., inclusive, and pressures in a range of 100-500 bar, inclusive.

In some embodiments, the combination of supercritical fluid with the one or more co-solvents can have a synergistic effect that improves operability, biocrude yield, and/or extraction pathway, as compared conventional hydrothermal liquefaction. For example, when the supercritical fluid is carbon dioxide, the incorporation of the supercritical fluid provides nonpolar solvent capabilities and catalytic capabilities of its weak Lewis acid and base. Such properties of the supercritical carbon dioxide can offer an improved environment for liquefaction, improve subsequent biocrude extractability from by-products, and/or reduce contaminated water resulting from the process.

In the extraction module 112, the biocrude 114 can be separated from the one or more by-products 118, for example, using the one or more solvents (e.g., at least the supercritical fluid). Alternatively or additionally, the extraction module 112 (or a separate module, not illustrated) can further separate the biocrude 114 from the one or more solvents (e.g., via pressure reduction), which separated solvent(s) can be recovered via output 116 and reused in subsequent processing. In some embodiments, the use of supercritical fluid to separate the biocrude from by-product(s) by the extraction module 112 can increase the desirable hydrocarbon and oil content in the biocrude, while leaving behind the unwanted by-product(s) (e.g., heavy-oxygenates, metals, water, etc.), for example, as raffinates.

In the illustrated example of FIG. 1, the de-watering module 104, the liquefaction module 108, and the extraction module 112 are illustrated as separate components, with the output of one module serving as input to a subsequent module. However, in some embodiments, the functions of some or all of the illustrated modules may instead be sequentially performed by a single module 122 (e.g., a single reactor). For example, supercritical fluid (with or without co-solvent(s)) and feedstock can be provided to a reactor, and the temperature and pressure thereof can be increased to a first level (e.g., temperature of about 20-60° C.) to provide a de-watering function. The de-watered feedstock can remain in the reactor (with the provision of additional supercritical fluid and/or co-solvent(s)), and the temperature and pressure of the reactor can be further increased to a second level (e.g., a temperature of about 150-500° C. and a pressure of about 100-500 bar) to provide the liquefaction function. Removing the supercritical fluid with biocrude dissolved therein from the reactor, while leaving behind the by-product(s) in the reactor, can provide the extraction function.

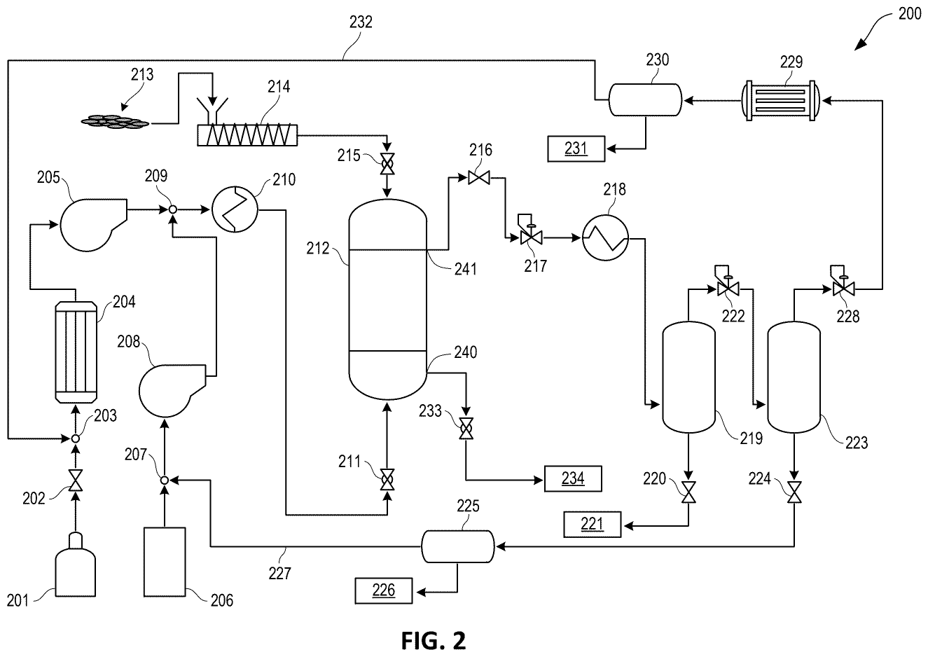

For example, FIG. 2 shows an exemplary system 200 for processing organic feedstock 213 into biocrude using a single reactor 212 to perform de-watering, liquefaction, and extraction processes. In the illustrated example, system 200 further includes a first solvent supply 201 (e.g., a liquid CO₂ supply container) and a second solvent supply 206 (e.g., co-solvent modifier liquid supply container). The first solvent supply 201 is connected to a heat exchanger 210 through supply valve 202, junction 203 (e.g., 3-way junction for recycled CO₂), chiller 204 (e.g., for cooling CO₂), fluid pump 205, and mixing region 209. The second solvent supply 206 is connected to the heat exchanger 210 through junction 207 (e.g., 3-way junction for recycled co-solvent), fluid pump 208, and mixing region 209. Mixed solvent (e.g., CO₂ and co-solvent) can be provided to a first inlet of the reactor 212 via inlet valve 211. Feedstock 213 (e.g., biomass and/or waste stream) can be provided to a second inlet of the reactor 212 via loading means 214 (e.g., conveyor system) and inlet valve 215.

After pyrolytic liquefaction, fluid (e.g., solvent mixture with biocrude dissolved therein) can be removed from the reactor 212 via a first outlet 241. An outlet valve 216 can be coupled to the first outlet 241, for example, for static and dynamic processing. The fluid from the first outlet 241 of the reactor 212 can be provided to a first collection vessel 219 (e.g., extract collection vessel) via a back pressure regulator 217 (e.g., to maintain regulated pressure in the reactor) and heat exchanger 218 (e.g., to compensate Joule-Thompson cooling). Simultaneously or subsequently, the remnants in the reactor 212 (e.g., heavy by-products including char and ash from the reaction and water residue stream) can be directed from a second outlet 240 of the reactor 212 as a by-product stream 234 (e.g., containing ash, solid-carbon, water, and non-oil extracts), for example, via outlet valve 233.

In the first collection vessel 219, the biocrude can be separated from the solvent mixture, with the separated solvent mixture being provided to a second collection vessel 223 (e.g., for co-solvent and other fractionates) via back pressure regulator 222 (e.g., to maintain collection pressure in vessel 219), and with the separated biocrude being provided as an output stream 221 (e.g., for further processing) via drain valve 220. In the second collection vessel 223, the solvent mixture can be separated into its constituent parts, for example, for recycling. A first outlet (e.g., containing the first solvent) of the second collection vessel 223 can be directed to junction 203 for reuse, via back pressure regulator 228 (e.g., to maintain collection pressure in vessel 223), catalytic oxygenator 229 (e.g., oxidation bed to convert any hydrocarbon gaseous by-products into CO₂), water separator 230, and recycle line 232. A second outlet (e.g., containing the second solvent) of the second collection vessel 223 can be directed to junction 207 for reuse, via drain valve 224, water separator 225, and recycle line 227. Water from water separators 225 and 230 can be output as water by-product streams 226 and 231, respectively.

In a non-limiting operation of system 200 using CO₂ as an exemplary first solvent, the CO₂ can be supplied from supply 201 through valve 202. Chiller 204 can reduce a temperature of the CO₂ to liquid temperatures (e.g., <10° C. at 55 bar). The liquid CO₂ can be pumped to high pressures (e.g., 100-500 bar) by pump 205, followed by pre-heating (e.g., temperature in a range of 30-200° C.) in heat exchanger 210. The second solvent from supply 206 can be pumped using a high-pressure liquid pump 208 to heat exchanger 210 for pre-heating. From the heat exchanger 210, the supercritical CO₂ and co-solvent mixture can enter the reactor 212 via valve 211. The solvation characteristics in the supercritical CO₂ can be tuned by adjusting temperature and/or pressure, and/or by appropriate selection of the second solvent.

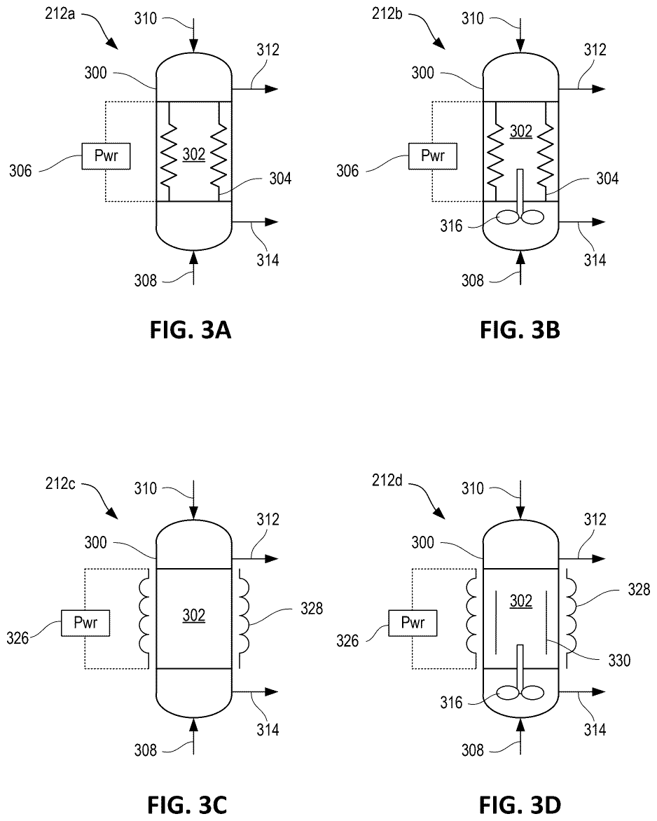

The feedstock 213 can be supplied into the reactor 212 via valve 215 using loading means 214, for example, in a batch manner for semi-continuous operation, or as a slurry/dispersion in the solvent mixture (e.g., liquid CO₂ and co-solvent) and/or water. In some embodiments, the feedstock within the reactor can be configured (e.g., packed) as a stationary bed, or bubbled using the incoming solvent mixture stream. The reactor 212 can be heated to temperatures in a range of 20-500° C., depending on if the feedstock is first being de-watered (e.g., 20-60° C.) or proceeding directly to liquefaction (e.g., 150-500° C.). In some embodiments, the reactor 212 can be heated via electrical heating, for example, Joule heating (e.g., resistance heating) or induction heating. For example, FIGS. 3A-3B show exemplary reactor configurations employing Joule heating and FIGS. 3C-3D show exemplary reactor configurations employing induction heating. Other heating methodologies and configurations beyond those specifically illustrated in FIGS. 3A-3D are also possible according to one or more contemplated embodiments.

In the example of FIG. 3A, reactor 212a has an enclosure 300 defining inlets 308, 310, outlets 312, 314, and an interior volume 302 for the feedstock and solvents in fluid communication with the inlets and outlets. The reactor 212a also has one or more electric heaters 304 connected to an electrical power supply 306. The electric heater(s) 304 can be disposed within the interior volume 302, for example, so as to directly contact the feedstock and/or to avoid heating through walls of the enclosure 300 (e.g., as would be the case with an external heater). In some embodiments, the heater(s) 304 can be constructed to survive high-pressures (e.g., 100-500 bar). For example, the heater(s) 304 can be installed onto walls of the enclosure 300, with electrical connections (e.g., lead lines or wires) outside the reactor. Alternatively, the heater(s) 304 can be disposed within the enclosure 300, with high-pressure electrical feedthroughs providing power to the lead wires. The power supplied by power supply 306 can be AC power or DC power. The reactor 212b in the example of FIG. 3B is similar to that of FIG. 3A, but additionally includes a stirring mechanism 316 (e.g., agitator or mixer) as feedstock mixing means. In some embodiments, the stirring mechanism 316 can allow for more uniform heating of the feedstock.

In the example of FIG. 3C, reactor 212c has an enclosure 300 defining inlets 308, 310, outlets 312, 314, and an interior volume 302 for the feedstock and solvents in fluid communication with the inlets and outlets, similar to the reactor of FIG. 3A. However, the reactor 212c has one or more inductive heaters 328 connected to an electrical power supply 326. For example, the inductive heaters 328 can comprise one or more induction coils wound around the enclosure 300, such that, when power is applied to the induction coils, eddy currents are induced within the walls of the enclosure 300 to cause self-heating thereof. In some embodiments, the enclosure can have additional wall linings (e.g., within the reactor) with higher relative magnetic permeability, so as to allow for faster heating within the reactor. The power supply by power supply 326 can be AC power.

The reactor 212d in the example of FIG. 3D is similar to that of FIG. 3B but additionally includes a stirring mechanism 316 and baffles 330 as feedstock mixing means. The baffles 330 disposed within interior volume 302 of the enclosure can enhance mixing of the feedstock. Alternatively or additionally, in some embodiments, baffles 330 and/or stirring mechanism 316 can be used for inductive heating. In such embodiments, the stirring mechanism 316 and/or baffles can be formed with a magnetic permeability higher than that of the walls of the enclosure 300.

Returning to FIG. 2, the reactor 212 can be run in a static mode (e.g., if additional residence time is needed for de-watering and/or liquefaction) or dynamic mode, which mode of operation may be controlled, at least in part, by closing or opening of valve 216. In static mode, once the reaction has been completed, the pressure inside the reactor 212 can be controlled by backpressure regulator 217, for example, to allow for continuous extraction of biocrude from the reactor 212. The high-quality oil product dissolved in the supercritical CO₂-co-solvent mixture can be heated in heat exchanger 218, for example, to just ensure a desired phase for the mixture or constituents thereof (e.g., fluid phase or vapor phase). Within first collection vessel 219, the stream can be depressurized such that the previously dissolved oils are collected as liquids while the CO₂ and co-solvent remain in gas form. An output stream 221 of high quality biocrude can thus be provided from collection vessel 219 via drain valve 220.

Back-pressure regulator 222 can maintain the pressure in the first collection vessel 219. Alternatively or additionally, the first collection vessel 219 may be at an elevated temperature (e.g., insulated and/or heated) to ensure the co-solvent remains in a vapor phase when transferred from the first collection vessel to the second collection vessel 223, which is at a lower temperature that causes the co-solvent to condense. The co-solvent, water, and any other dissolved contaminants can be collected through drain valve 224. Separator 225 separates the output from drain valve 224 into co-solvent and water, with the separated co-solvent re-entering the main co-solvent stream at junction 207. Back-pressure regulator 228 can maintain the pressure in the second collection vessel 223. Depressurized CO2 along with a product gas stream can be directed via back-pressure regulator 228 to catalytic oxygenator 229, where product gases with calorific value (e.g., CO, CH₄) can be oxidized into CO₂ and H₂O. The resulting outlet stream from oxygenator 229 may thus be only CO₂ and water. The water can be separated from the CO₂ in separator 230, followed by filtration and wet scrubbing of additional contaminants (not shown) to provide a recycled CO₂ stream to junction 203 via recycle line 232.

Although the discussion above suggests that the solvent provided to the reactor is already in a supercritical state, it is also possible in some embodiments for the solvent to be converted to a supercritical fluid after provision to the reactor (either with or without the feedstock and/or co-solvent(s) already therein), for example, by appropriate adjustment of the temperature and/or pressure. Other configurations and processes beyond those specifically illustrated in FIGS. 1-3D are also possible according to one or more contemplated embodiments.

### Exemplary Methods for Processing Organic Materials

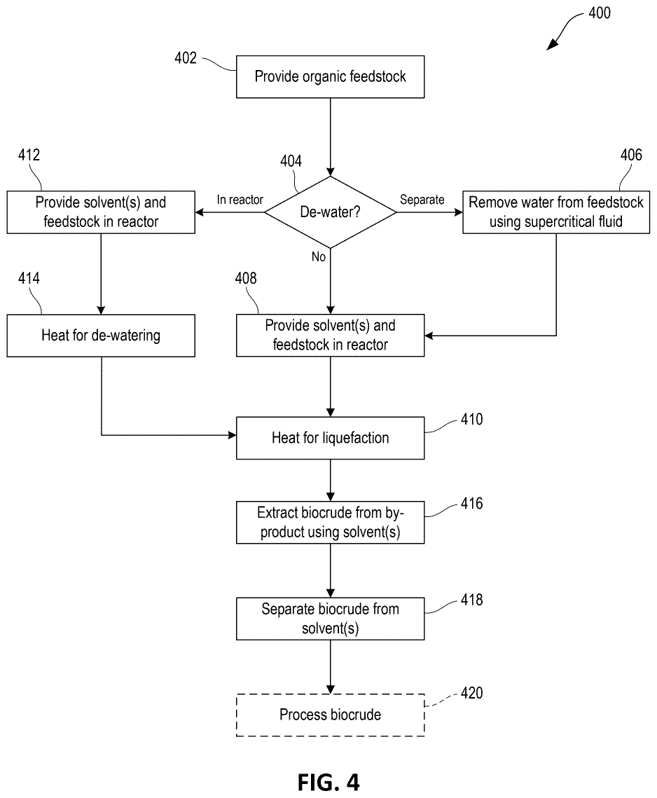

FIG. 4 illustrates an exemplary method 400 for processing organic materials, for example, to form biocrude and/or biofuels. The method 400 can begin at process block 402, where an organic feedstock can be provided. In some embodiments, the organic feedstock can comprise biomass and/or a waste stream. In some embodiments, the provided organic feedstock has already been de-watered or otherwise has a sufficiently low moisture content (e.g., ≤10 wt %). Alternatively, in some embodiments, the organic feedstock may have moisture retained therein or be provided in water (e.g., slurry). In some embodiments, the provision of feedstock can include means for moving and/or loading of the feedstock, such as but not limited to a belt conveyor, hopper loader, screw conveyor, auger feeder, pneumatic conveying device (e.g., using air pressure or vacuum to transport feedstock through a conduit), gravity chute, slurry pump, and/or lock hopper. Other means for delivering the feedstock to a reactor are also possible according to one or more contemplated embodiments.

The method 400 can proceed to decision block 404, where it is determined if de-watering is needed. As noted above, in some embodiments, the provided feedstock already has a low moisture content, and thus the method can proceed directly to process block 408. Alternatively, if the provided feedstock does not have a sufficiently low moisture content, the organic feedstock may be subject to de-watering. In some embodiments, the de-watering may be performed in a separate stage (e.g., reactor) from that used to perform liquefaction. In such embodiments, the method 400 can proceed from decision block 404 to process block 406, where water can be removed from the feedstock using a supercritical fluid, for example, by subjecting to an elevated temperature (e.g., 20-60° C.) for a predetermined period of time (e.g., 30-200 minutes).

The method 400 can proceed from decision block 404 or process block 406 to process block 408, where the feedstock can be provided in a reactor for liquefaction. Prior to being provided to the reactor, or at least within the reactor, the feedstock can be combined with one or more solvents, at least one of which is the supercritical fluid (or becomes a supercritical fluid by application of appropriate temperature and pressure during the liquefaction). In some embodiments, the one or more solvents includes at least one co-solvent, for example, a polar solvent, an organic solvent, and/or a gas-phase solvent. The co-solvent(s) can be combined with the supercritical fluid or separately introduced to the feedstock and/or reactor.

Alternatively, in some embodiments, the de-watering may be performed in the same stage (e.g., reactor) used to perform liquefaction. In such embodiments, the method 400 can proceed from decision block 404 to process block 412, where the feedstock can be provided in a reactor for de-watering and subsequent liquefaction. Prior to being provided to the reactor, or at least within the reactor, the feedstock can be combined with one or more solvents, at least one of which is a supercritical fluid (or becomes a supercritical fluid by application of appropriate temperature and pressure during the liquefaction). In some embodiments, the one or more solvents includes at least one co-solvent, for example, a polar solvent, an organic solvent, and/or a gas-phase solvent. The co-solvent(s) can be combined with the supercritical fluid or separately introduced to the feedstock and/or reactor.

The method 400 can proceed from process block 412 to process block 414, where water can be removed from the feedstock using supercritical fluid, for example, by subjecting to an elevated temperature (e.g., 20-60° C., inclusive) for a predetermined period of time (e.g., 30-200 minutes, inclusive). In some embodiments, the reactor is heated to the elevated temperature at a heating rate that promotes substantially uniform and/or fast heating of the feedstock, for example, at a rate of 5-1000° C./minute, inclusive (e.g., within a range of 50-150° C./minute, inclusive, such as 60-120° C./minute, inclusive).

Once sufficient water has been removed at process block 414, or after process block 408, the method 400 can proceed to process block 410, where the combination of feedstock and solvent(s) are subjected to one or more conditions that cause liquefaction (e.g. pyrolytic liquefaction) of the feedstock, so as to convert the organic feedstock into biocrude and one or more by-products. In some embodiments, the one or more conditions comprise temperature of at least 150° C. and/or pressure of at least 100 bar. In some embodiments, the reactor can be heated to a temperature in a range greater than that used for de-watering, for example, 150-500° C. compared to 20-60° C. for de-watering. Alternatively or additionally, pressures during the liquefaction of process block 410 can be in a range of 100-500 bar, inclusive. In some embodiments, the reactor is heated (e.g., from room temperature or the elevated temperature) to the temperature of the one or more conditions at a heating rate that promotes substantially uniform and/or fast heating of the feedstock, for example, at a rate of 5-1000° C./minute, inclusive (e.g., within a range of 50-150° C./minute, inclusive, such as 60-120° C./minute, inclusive).

In some embodiments, the heating of the reactor to achieve the temperature of the one or more conditions in process block 410 and/or the heating to effect the de-watering of process block 406 or 414 can be achieved via Joule heating (e.g., using electrical heaters disposed within the reactor or otherwise in thermal communication with the feedstock in the reactor), inductive heating (e.g., to heat parts of the reactor or other components in thermal communication with the feedstock in the reactor), gas heating (e.g., using combustion of one or more gases), and microwave heating. In some embodiments, the feedstock can be agitated or stirred during the heating and/or during the one or more conditions, for example, via a mechanical stirrer and/or one or more baffles disposed within the reactor.

Once the feedstock has been converted to biocrude and by-products, or once some other predetermined criteria has been reached (e.g., time allowed for reaction), the method 400 can proceed to process block 416, where the biocrude dissolved in the solvent(s) can be separated from the by-product(s) by removing the solvent(s) from the reactor. Alternatively or additionally, the by-product(s) can also be removed from the reactor, for example, for disposal and/or in anticipation of processing a subsequent batch of feedstock. The method 400 can proceed to process block 418, where the biocrude can be separated from the solvent(s), for example, by changing a solubility of the solvent(s) (e.g., by changing a temperature and/or pressure thereof). The method 400 can then optionally proceed to process block 420, where the biocrude may be subject to further processing, for example, to convert the biocrude into one or more value added products (e.g., biofuels). For example, the further processing of the biocrude can include, but is not limited to, hydrotreating (e.g., by subjecting to elevated pressure (e.g., ≥100 bar) and elevated temperature (e.g., ≥300° C.) in the presence of hydrogen gas, a hydrogen donor, and/or an appropriate catalyst).

Although blocks 402-420 of method 400 have been described as being performed once, in some embodiments, multiple repetitions of a particular block may be employed before proceeding to the next decision block or process block. In addition, although blocks 402-420 of method 400 have been separately illustrated and described, in some embodiments, process blocks may be combined and performed together (simultaneously or sequentially). Moreover, although FIG. 4 illustrates a particular order for blocks 402-420, embodiments of the disclosed subject matter are not limited thereto. Indeed, in certain embodiments, the blocks may occur in a different order than illustrated or simultaneously with other blocks. In some embodiments, method 400 can include steps or other aspects not specifically illustrated in FIG. 4. Alternatively or additionally, in some embodiments, method 400 may comprise only some of blocks 402-420 of FIG. 4.

### Computer Implementation Examples

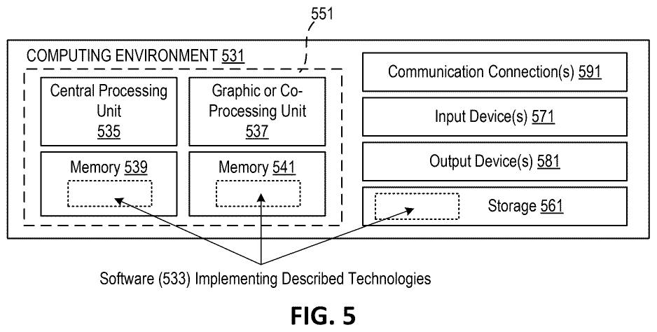

FIG. 5 depicts a generalized example of a suitable computing environment 531 in which the described innovations may be implemented, such as but not limited to aspects of controller 120, a controller of system 200, controllers of components of reactors 212a-212d, and/or method 400. The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet, etc.).

With reference to FIG. 5, the computing environment 531 includes one or more processing units 535, 537 and memory 539, 541. In FIG. 5, this basic configuration 551 is included within a dashed line. The processing units 535, 537 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 5 shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for other software executing in the computing environment 531, and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Conclusion

Any of the features illustrated or described herein, for example, with respect to FIGS. 1-5, can be combined with any other feature illustrated or described herein, for example, with respect to FIGS. 1-5, to provide configurations, systems, devices, structures, methods, aspects, or embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicant therefore claims all that comes within the scope and spirit of these claims.

1. A method comprising:
(a) providing organic feedstock in a reactor with one or more solvents, the one or more solvents comprising a supercritical fluid;
(b) subjecting the organic feedstock and the one or more solvents in the reactor to one or more conditions that cause liquefaction of the organic feedstock, so as to convert the organic feedstock into biocrude and one or more by-products; and
(c) after (b), flowing the one or more solvents with the biocrude dissolved therein from the reactor, such that the biocrude is separated from the one or more by-products.

2. The method of claim 1, wherein the one or more conditions comprise a temperature of at least 150° C. and/or a pressure of at least 100 bar.

3. The method of claim 1, wherein the one or more conditions comprise:
a temperature in a range of 150-500° C., inclusive;
a pressure in a range of 100-500 bar, inclusive; or
both of the above.

4. The method of claim 1, further comprising, after (b), separating the biocrude from the one or more solvents.

5. The method of claim 1, further comprising, after (c), processing the biocrude to produce one or more biofuels.

6. The method of claim 1, wherein the organic feedstock comprises a biomass or a waste stream.

7. The method of claim 1, further comprising, prior to (b), removing at least some water from the organic feedstock.

8. The method of claim 7, wherein:
the removing at least some water is performed after (a) with the organic feedstock and the one or more solvents in the reactor, and
the removing comprises heating the organic feedstock and the one or more solvents in the reactor to an elevated temperature greater than a critical point temperature of the supercritical fluid.

9. The method of claim 8, wherein the elevated temperature is less than a temperature of the one or more conditions that cause liquefaction in (b).

10. The method of claim 8, wherein the elevated temperature is in a range of 20-60° C., inclusive.

11. The method of claim 8, wherein the heating to the elevated temperature comprises increasing temperature of the organic feedstock and the one or more solvents to the elevated temperature at a heating rate in a range of 5-1000° C./minute, inclusive.

12. The method of claim 7, wherein the removing at least some water is performed prior to (a).

13. The method of claim 1, wherein the one or more solvents comprises one or more co-solvents, each co-solvent being one of a polar solvent, an organic solvent, and/or gas-phase solvent.

14. The method of claim 13, wherein the one or more co-solvents comprises residual water from the organic feedstock, a portion of biocrude, or a portion of the one or more by-products.

15. The method of claim 13, wherein the one or more co-solvents comprises an alcohol, carboxylic acid, an aromatic, a hydrocarbon, a halocarbon, a phenolic, an aldehyde, a ketone, ammonia (NH₃), propane (C₃H₈), acetylene (C₂H₂), or any combination of the foregoing.

16. The method of claim 1, wherein the supercritical fluid is carbon dioxide.

17. The method of claim 1, wherein, during at least part of the subjecting of (b), the organic feedstock is stirred within the reactor.

18. The method of claim 1, wherein the subjecting of (b) comprises:
heating via electrical heaters disposed within the reactor; or
inductive heating of the reactor or a portion thereof.

19. A system comprising:
one or more supplies of one or more solvents;
a reactor;
a fluidic network interconnecting the one or more supplies and the reactors; and
a controller comprising one or more processors and one or more non-transitory computer-readable storage media, the computer-readable storage media storing computer-readable instructions that, when executed by the one or more processors, cause the system to:
provide organic feedstock in the reactor with the one or more solvents via the fluidic network, the one or more solvents in the reactor comprising a supercritical fluid;
subject the organic feedstock and the one or more solvents in the reactor to one or more conditions that cause liquefaction of the organic feedstock, so as to convert the organic feedstock into biocrude and one or more by-products; and
flow the one or more solvents with the biocrude dissolved therein from the reactor via the fluidic network, such that the biocrude is separated from the one or more by-products.

20. The system of claim 19, wherein the reactor comprises:
an electrical heater or an inductive heater constructed to heat the organic feedstock and the one or more solvents in the reactor to a temperature of at least 150° C. during the subjecting to the one or more conditions; and/or
a stirrer constructed to stir the organic feedstock within the reactor during the subjecting to the one or more conditions.
